(19) United States
(12) Patent Application Publication
(10) Pub. No.: US 2013/0000457 A1
(43) Pub. Date: Jan. 3, 2013

(54) ROTARY WORKING APPARATUS

(75) Inventors: Kenji Oba, Kagawa (JP); Hideaki Miyauchi, Kagawa (JP)

(73) Assignee: Uni-Charm Corporation, Ehime (JP)

(21) Appl. No.: 13/576,480

(22) PCT Filed: Feb. 1, 2011
(86) PCT No.: PCT/JP2011/052463

§ 371 Date: Aug. 1, 2012

(30) Foreign Application Priority Data
Feb. 1, 2010 (JP) 2010-020729

(51) Int. Cl. B26F 1/44

(52) U.S. Cl. 83/344

(57) ABSTRACT

A rotary working apparatus provided with a working unit and an actuator, wherein the working unit is provided with a unit frame and a cutter roll and anvil roll supported by the unit frame so as to be rotatable about mutually parallel axes of rotation, the anvil roll being further supported by the unit frame in a movable manner. The actuator is provided at the outside of the working unit and is provided with advanceable/retractable rods for making the anvil roll move to press the anvil roll against the cutter roll. A workpiece fed between the cutter roll and the anvil roll is worked by the rotating cutter roll and/or anvil roll.

### TECHNICAL FIELD

The present invention relates to a rotary working apparatus.

### BACKGROUND ART

Known in the art is a rotary cutting apparatus having a cutting unit provided with a unit frame, a fixed roll and a movable roll supported at the unit frame to be rotatable about mutually parallel axes of rotation, and an actuator for making the movable roll move to press the movable roll against the fixed roll, a workpiece fed between the fixed roll and the movable roll being cut by the fixed roll and the movable roll (see PLT 1).

That is, in this rotary cutting apparatus, a hydraulic cylinder is integrally assembled inside the unit frame.

Further, in such a rotary cutting apparatus, when the cutter roll or the hydraulic cylinder should be replaced, the cutting unit as a whole is replaced with a new unit. By doing this, the replacement of parts becomes easier.

### CITATION LIST

### Patent Literature

PLT 1: Japanese Patent Publication (A) No. 2004-25408

### SUMMARY OF INVENTION

### Technical Problem

However, in the rotary cutting apparatus of PLT 1, since the unit frame has the hydraulic cylinder assembled in it, the unit frame inevitably becomes larger in height dimension. For this reason, the center of gravity of the cutting unit is at a relatively high position. As a result, in particular if the working speed becomes high, the unit frame will greatly vibrate and the unit frame will experience strain or the cutting blade will violently strike the roll and therefore the cutting blade will be liable to become shorter in lifetime.

If raising the rigidity of the unit frame, this problem might be able to be solved, but in this case, the weight of the cutting unit would become larger and the replacement of the cutting unit would be liable to become difficult.

An object of the present invention is to provide a rotary working apparatus which is able to suppress vibration of the working unit while allowing easy replacement of the working unit.

### Solution to Problem

According to the present invention, there is provided a rotary working apparatus comprising: a working unit provided with a unit frame and a fixed roll and a movable roll supported by the unit frame so as to be rotatable about mutually parallel axes of rotation, the movable roll being further supported by the unit frame so as to be able to move; and an actuator provided at the outside of the working unit, the actuator provided with advanceable/retractable rods for making the movable roll move to press the movable roll against the fixed roll, wherein a workpiece fed between the fixed roll and the movable roll is worked by the rotating fixed roll and/or movable roll.

### Advantageous Effects of Invention

It is possible to suppress vibration of the working unit while allowing easy replacement of the working unit.

### BRIEF DESCRIPTION OF THE DRAWINGS

FIG. 1 is a front view of a rotary cutting apparatus.

FIG. 2 is a side view of a rotary cutting apparatus.

### DESCRIPTION OF EMBODIMENTS

Below, the case of application of the present invention to a rotary cutting apparatus for cutting or cutting out pieces from a workpiece will be explained. However, the present invention can also be applied to a rotary working apparatus for heat sealing, pressing, embossing, or otherwise working the workpiece. Here, the “workpiece” is, for example, comprised of a sheet-like plastic film, nonwoven fabric, combination of the same, etc. and is used for producing absorbent products such as sanitary napkins or diapers. In this case, the rotary cutting apparatus forms part of the absorbent product manufacturing apparatus.

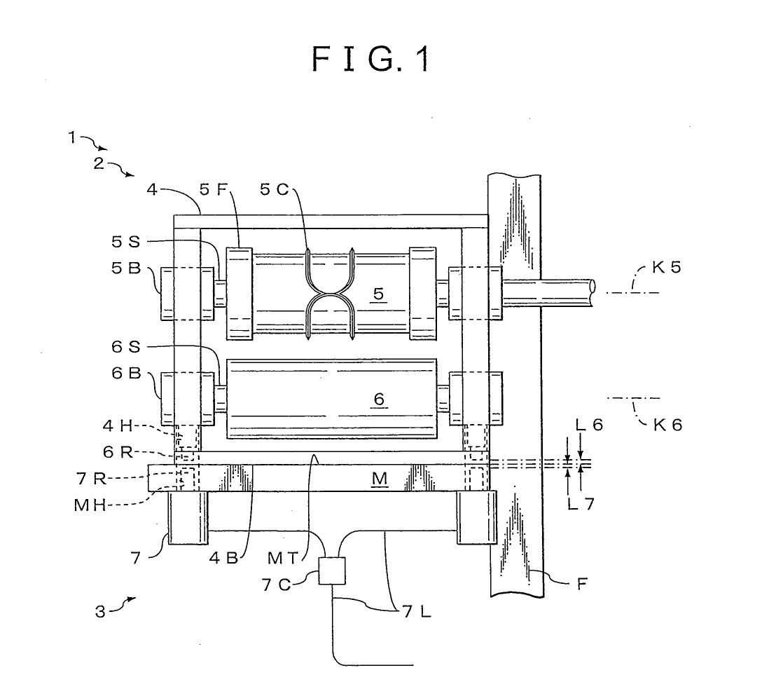

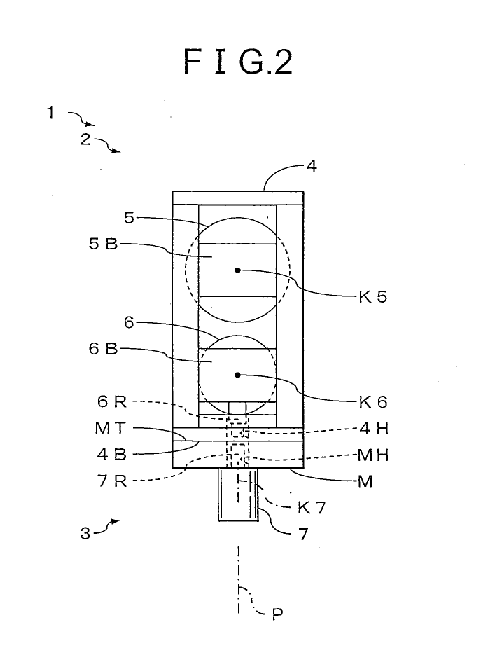

Referring to FIG. 1 and FIG. 2, the rotary cutting apparatus 1 is provided with a working unit 2 comprised of a cutting unit and with an actuator 3.

The cutting unit 2 is provided with a unit frame 4, a cutter roll 5 having cutting blades 50 and a pair of flanges 5F, and an anvil roll 6. A shaft 5S of the cutter roll 5 is supported by a pair of bearings 5B so as to be able to rotate about an axis of rotation K5, while a shaft 6S of the anvil roll 6 is supported by a pair of bearings 6B so as to be able to rotate about an axis of rotation K6. The axes of rotation K5 and K6 extend in the substantially horizontal direction, therefore the cutter roll 5 and the anvil roll 6 are supported to be able to rotate about the substantially mutually parallel axes of rotation K5 and K6.

The shaft 5S of the cutter roll 5 is coupled with a drive device (not shown). The cutter roll 5 and the anvil roll 6 are coupled with each other by gears (not shown). If the drive device is operated, the cutter roll 5 and the anvil roll 6 rotate in opposite directions to each other.

The bearings 5B for the cutter roll 5 are attached to the unit frame 4 in an immovable manner, while the bearings 6B for the anvil roll 6 are attached to the unit frame 4 in a movable manner. Therefore, the anvil roll 6 is designed to be able to move with respect to the unit frame 4 or the cutter roll 5. That is, in the embodiment according to the present invention, the cutter roll 5 forms a fixed roll, while the anvil roll 6 forms a movable roll. Alternatively, the cutter roll 5 and anvil roll 6 may form a movable roll and fixed roll, respectively.

The unit frame 4 is formed with a pair of through holes 4H opening at the bottom surface of the unit frame 4. These through holes 4H have a pair of intermediate rods 6R attached to them in a movable manner. The bearings 6B for the anvil roll 6 are placed on the intermediate rods 6R.

On the other hand, the actuator 3 is provided with a pair of hydraulic cylinders 7. Each hydraulic cylinder 7 has a cylinder rod 7R which can advance or retract along an axis of movement K7. These hydraulic cylinders 7 are connected through the hydraulic lines 7L and coupling 7C to a hydraulic pressure feeder/discharger (not shown). If the hydraulic pressure of the hydraulic cylinders 7 is controlled, the cylinder rods 7R advance or retract. The cylinder rods 7R form the rods of the actuator 3. Note that, the actuator 3 can alternatively be comprised of a pneumatic cylinder, electric motor, etc.

The actuator 3 is attached to the bottom side of a mount M attached to the frame F of the absorbent product manufacturing apparatus. The mount M is formed with a pair of through holes MH opening at the top surface or mounting table MT of the mount M. The cylinder rods 7R are designed to be able to move through the through holes MH. Here, the inside diameters of the through holes MH are preferably slightly larger than the outside diameters of the cylinder rods 7R. This is so as to enable dirt etc. to be kept from depositing or building up around the cylinder rods 7R.

On the other hand, the cutting unit 2 is placed on the mounting table MT of the mount M and is fixed there in a detachable manner. In this case, the cutting unit 2 is attached on the mount M so that the through holes 4H of the unit frame 4 and the through holes MH of the mount M are mutually aligned. Therefore the intermediate rods 6R and the cylinder rods 7R are aligned with each other. Further, as shown in FIG. 2, the axes of rotation K5 and K6 of the cutter roll 5 and the anvil roll 6 and the axis of movement K7 of the cylinder rods 7R are positioned in the same plane extending in substantially the vertical direction. Note that, the mounting table MT extends in substantially the horizontal direction.

FIG. 1 and FIG. 2 show the case where the rotary cutting apparatus 1 is at the standby position. At this standby position, the intermediate rods 6R are at the lowest positions which they can take, while the cylinder rods 7R are at their most retracted positions. At the standby position, the bottom surfaces of the intermediate rods 6R are positioned above from the bottom surface 4B of the unit frame 4 by the distance L6, therefore do not project out downward from the bottom surface 4B. Further, the top surfaces of the cylinder rods 7R are positioned below the mounting table MT of the mount M by the distance L7, therefore do not project out upward from the mounting table MT of the mount M.

Here, to keep dirt etc. from clogging the through holes 4H and MH, preferably, the distances L6 and L7 are approximately between 0 and 1 mm.

When operating the rotary cutting apparatus 1, the cylinder rods 7R are advanced. As a result, the cylinder rods 7R abut against the intermediate rods 6R, and the intermediate rods 6R are pushed up together with the bearings 6B. For this reason, the anvil roll 6 is made to move toward the cutter roll 5, and the circumferential surface of the anvil roll 6 is pressed against the circumferential surfaces of the flanges 5F of the cutter roll 5. In this case, the hydraulic pressures of the hydraulic cylinders 7 are controlled so that the cutter roll 5 and anvil roll 6 contact each other by the target pressure.

Next, the cutter roll 5 and anvil roll 6 rotate, and the workpiece is fed between the cutter roll 5 and anvil roll 6. As a result, the workpiece is cut to the target shapes by the cutting blades 5C of the cutter roll 5.

In this way, in the embodiment according to the present invention, the actuator 3 is provided at the outside of the cutting unit 2 and is provided separate from the cutting unit 2. As a result, the height dimension of the unit frame 4 can be reduced and the center of gravity position of the cutting unit 2 can be lowered. Therefore, it is possible to suppress vibration acting on the cutting unit 2 and is possible to reduce strain occurring at the unit frame 4 and extend the lifetime of the cutting blades 5C. The fact that in the rotary cutting apparatus 1 of the embodiment of the present invention, the number of times that the workpiece can be cut well becomes about 1.8 times that of the case where the actuator is assembled in the working unit is confirmed by experiments.

Further, the weight of the cutting unit 2 becomes smaller, so it is possible to easily replace the cutting unit 2 with a new cutting unit 2. That is, when a problem occurs in a component element of the cutting unit 2, for example, the cutter roll 5, the cutting unit 2 is replaced by a new cutting unit. In this case, the cutting unit 2 which had been used is slid off from the mount M. When sliding the cutting unit 2 in this way, by lightening the cutting unit 2, the replacement work becomes easy.

Furthermore, at the standby position, the intermediate rods 6R do not project out downward from the bottom surface 4B of the unit frame 4, and the cylinder rods 7R. do not project out upward from the mounting table MT of the mount M. As a result, to replace the cutting unit 2, it is possible to easily slide off the cutting unit 2.

Further, the cutting unit 2 does not include an actuator 3, so it is possible to cheaply produce a spare cutting unit 2. Furthermore, when the actuator 3 is malfunctioning, it is sufficient to replace the actuator 3. There is no need to replace the cutting unit 2. Therefore, it is possible to simply replace the cutting unit 2 and possible to greatly reduce the cost required for the rotary cutting apparatus 1.

Furthermore, when replacing the cutting unit 2, it is not necessary to detach the hydraulic lines 7L from the hydraulic cylinders 7. Therefore, regarding this point as well, it is possible to easily replace the cutting unit 2. Furthermore, if detaching the hydraulic lines 7L, the working oil is liable to leak out or air is liable to enter into the hydraulic lines 7L, but in the embodiment according to the present invention, such problems will not occur.

Furthermore, in the embodiment according to the present invention, the axes of rotation K5 and K6 of the cutter roll 5 and the anvil roll 6 and the axis of movement K7 of the cylinder rods 7R are positioned in the same plane P (FIG. 2). Further, at the time of operation of the rotary cutting apparatus 1, when the flanges 5F of the cutter roll 5 and the anvil roll 6 contact each other at contact lines parallel to the axes of rotation K5 and K6, these contact lines are also positioned in the plane P. As a result, the runout of the anvil roll 6 to the bottom, which can occur at the time of cutting a workpiece, can be effectively suppressed by the cylinder rods 7R. Therefore, changes in clearance between the cutting blades 5C and the circumferential surface of the anvil roll 6 and the vibration occurring as a result can be effectively suppressed and poor cutting can be reliably suppressed.

### Example

A rotary cutting apparatus 1 of the following specification was prepared. That is, the unit frame 4 was made from SS-400, while the bearings 5B and 6B were roller bearings. The cutting blades 5C were made from cemented carbide. The cutting edges of the cutting blades 5C were made to project out from the circumferential surfaces of the flanges 5F by 2 μm. The anvil roll 6 was made from high strength steel. The circumferential surface of the anvil roll 6 was polished smooth for finishing. The surface length of the cutter roll 5 was 250 mm, while the diameter was 150 mm. The cutting blades 5C were provided so that two products are cut out with each turn of the cutter roll 5. The initial pressure of the anvil roll 6 pushing against the cutter roll 5 was set to 1 MPa. The workpiece was cut and products produced at a rate of 1000 pcs/min (roll rotational speed 500 rpm). The cut parts of the products were made of a basis weight 25 g/m² polyolefin nonwoven fabric and a thickness 25 μm polyethylene film bonded together by a hot melt adhesive. Next, an absorbent product manufacturing apparatus in which the rotary cutting apparatus 1 of FIG. 1 is assembled was operated continuously for a long period of time and the number of products produced at the rotary cutting apparatus 1 until incomplete cutting started to occur was counted.

### Comparative Example

A rotary cutting apparatus in which the hydraulic cylinder was assembled in the working unit was prepared (for example, see Japanese Patent Publication (A) No. 2004-25408 etc.) Products were produced by similar specifications and operating procedures as in the example of the present invention.

### Results of Experiment

The number of products produced by the rotary cutting apparatus until incomplete cutting was about 10 million in the comparative example, while was about 18 million in the example of the present invention. Therefore, the rotary cutting apparatus according to the present invention becomes longer in lifetime.

In the embodiments explained up to here, the actuator 3 is provided below the mount M. However, so long as separate from the cutting unit 2, the actuator 3 can also be placed on the mounting table MT of the mount M.

Further, the mounting table MT of the mount M may also be inclined with respect to the horizontal direction. In this case, the plane P is inclined with respect to the vertical direction.

Furthermore, the intermediate rods 6R can be omitted. In this case, the cylinder rods 7R are constructed to directly abut against the bearings 6B when they have to press the anvil roll 6 against the cutter roll 5, and to retract to a position in which they do not project out upward from the mounting table MT of the mount M at the standby position.

### REFERENCE SIGNS LIST

1 rotary cutting apparatus
2 cutting unit
3 actuator
4 unit frame
4H through holes
5 cutter roll
5B bearings
5C cutting blades
5S shaft
6 anvil roll
6B bearings
6R intermediate rods
6S shaft
7 hydraulic cylinders
7R cylinder rods
K5, K6 axes of rotation
M mount
MT mounting table

1. A rotary working apparatus comprising:
a working unit provided with a unit frame and a fixed roll and a movable roll supported by the unit frame so as to be rotatable about mutually parallel axes of rotation, the movable roll being further supported by the unit frame so as to be able to move; and
an actuator provided at the outside of the working unit, the actuator provided with advanceable/retractable rods for making the movable roll move to press the movable roll against the fixed roll,
wherein a workpiece fed between the fixed roll and the movable roll is worked by the rotating fixed roll and/or movable roll.

2. A rotary working apparatus as set forth in claim 1, wherein the working unit is positioned on a mounting table of a mount in a detachable manner, and the actuator is provided below the mount.

3. A rotary working apparatus as set forth in claim 2, wherein the rods of the actuator can retract to a position in which they do not project out upward from the mounting table of the mount.

4. A rotary working apparatus as set forth in claim 2, wherein the mount is formed with through holes, and the rods of the actuator pass through the through holes to cause the movable roll to move.

5. A rotary working apparatus as set forth in claim 2, wherein the movable roll is configured to be moved by the rods of the actuator through intermediate rods, and the intermediate rods are provided so as not to project out downward from a bottom surface of the unit frame.

6. A rotary working apparatus as set forth in claim 1, wherein the actuator comprises a hydraulic cylinder.

7. A rotary working apparatus as set forth in claim 1, wherein the axes of rotation of the fixed roll and the movable roll and an axis of movement of the rods of the actuator are in the same plane.

8. A rotary working apparatus as set forth in claim 3, wherein the mount is formed with through holes, and the rods of the actuator pass through the through holes to cause the movable roll to move.

9. A rotary working apparatus as set forth in claim 3, wherein the movable roll is configured to be moved by the rods of the actuator through intermediate rods, and the intermediate rods are provided so as not to project out downward from a bottom surface of the unit frame.

10. A rotary working apparatus as set forth in claim 4, wherein the movable roll is configured to be moved by the rods of the actuator through intermediate rods, and the intermediate rods are provided so as not to project out downward from a bottom surface of the unit frame.

11. A rotary working apparatus as set forth in claim 8, wherein the movable roll is configured to be moved by the rods of the actuator through intermediate rods, and the intermediate rods are provided so as not to project out downward from a bottom surface of the unit frame.

12. A rotary working apparatus as set forth in claim 2, wherein the actuator comprises a hydraulic cylinder.

13. A rotary working apparatus as set forth in claim 3, wherein the actuator comprises a hydraulic cylinder.

14. A rotary working apparatus as set forth in claim 4, wherein the actuator comprises a hydraulic cylinder.

15. A rotary working apparatus as set forth in claim 5, wherein the actuator comprises a hydraulic cylinder.

16. A rotary working apparatus as set forth in claim 8, wherein the actuator comprises a hydraulic cylinder.

17. A rotary working apparatus as set forth in claim 9, wherein the actuator comprises a hydraulic cylinder.

18. A rotary working apparatus as set forth in claim 10, wherein the actuator comprises a hydraulic cylinder.

19. A rotary working apparatus as set forth in claim 11, wherein the actuator comprises a hydraulic cylinder.

20. A rotary working apparatus as set forth in claim 2, wherein the axes of rotation of the fixed roll and the movable roll and an axis of movement of the rods of the actuator are in the same plane.
